(19) United States
(12) Patent Application Publication
(10) Pub. No.: US 2016/0075595 A1
(43) Pub. Date: Mar. 17, 2016

(54) BUFFER LAYER FOR PREVENTING BREAKAGE OF GLASS PANEL FOR PANORAMIC SUNROOF, GLASS PANEL COMPRISING THE SAME, AND MANUFACTURING METHOD FOR THE SAME

(71) Applicant: INDUSTRY-ACADEMIC COOPERATION FOUNDATION YONSEI UNIVERSITY, Seoul (KR)

(72) Inventors: Yong Hoon JANG, Seoul (KR); Sung Woon CHA, Goyang-si (KR); Yoon Kwang LEE, Ansan-si (KR); Hyung-Ho PARK, Seoul (KR)

(21) Appl. No.: 14/852,276

(22) Filed: Sep. 11, 2015

(30) Foreign Application Priority Data
Sep. 12, 2014 (KR) 10-2014-0121118

(51) Int. Cl. C03C 17/34; C03B 23/023; C04B 35/10

(52) U.S. Cl. CPC C03C 17/3435; C03C 17/3488; C04B 35/10; C03B 23/023; C03C 2217/78

(57) ABSTRACT

The present invention relates to a buffer layer for preventing breakage in a panoramic sunroof glass panel, a glass panel including the buffer layer, and a manufacturing method for the glass panel, and more particularly, to a technique of preventing breakage in the region with a ceramic coating layer in a glass panel for panoramic sunroof by providing a physical/chemical/mechanical buffer layer between the tempered glass and the ceramic coating layer, while the ceramic coating layer is vulnerable to impact and likely to break.

### CROSS-REFERENCE TO RELATED APPLICATIONS

This application claims priority to Korean Application No. 10-2014-0121118, filed on Sep. 12, 2014, the contents of which are incorporated herein by reference in its entirety.

### BACKGROUND

1. Field of the Invention

The present invention relates to a buffer layer for preventing breakage of a glass panel for panoramic sunroof, a glass panel including the buffer layer, and a manufacturing method for the glass panel. More particularly, the present invention relates to a technology for preventing breakage of a panoramic sunroof in a panoramic sunroof glass panel using a tempered glass by providing a physical/chemical/mechanical buffer layer in the interface of a region on which a ceramic coating layer vulnerable to mechanical impact is formed.

2. Description of Related Art

The buffer layer of the present invention is applicable to a glass roof that is installed on a vehicle and made of a tempered glass. Specifically, the buffer layer of the present invention can be applied to the panoramic sunroof, panoramic glass roof or moon roof, and more specifically to a region with a ceramic coating layer on in the panoramic sunroof.

In general, an automotive sunroof is an opening structure in the form of a glass window in an automobile roof that allows the passengers to look out the window and admits fresh air to enter the passenger compartment. Further, a panoramic sunroof is a fixed or operable glass window that offers openings in the top of a vehicle, that is, automobile roof, so as to offer good openness and daylighting and gracious looks of the vehicle, and thus has become newly prominent in the field of sunroof.

The panoramic sunroof consists of a frame for mounting and fixing a sunroof on a vehicle; roller blinds installed inside of the vehicle to block out light; mechanical parts for operating the sunroof; a motor for supplying power to open/close the sunroof; auxiliary parts such as side moldings for exterior decoration of the space portions between the vehicle and the sunroof; and a glass panel covering the topside of the vehicle. FIG. 1 is a schematic diagram showing a glass panel as one of the components of a panoramic sunroof. Generally, the glass panel consists of a deflextor 1 disposed on the front side to block out light and wind; a moving glass 2 generally operated to open/close and functioning as a shade; and a fixed glass 3 disposed on the rear side, fixedly installed and not operable to open/close.

In the glass panel of FIG. 1, the blue part indicates a ceramic coating layer (also called “enamel coating layer”) and the rest is the transparent tempered glass region. The ceramic coating layer is generally formed at the edge of the glass panel to prevent damages such as scratches on the surface of the glass panel possibly caused by the roller or the like that is in direct contact with the surface of the glass panel while the glass panel attached to a vehicle body is operated to open or close. The ceramic coating layer is also to conceal all interior materials formed between the vehicle body and the glass panel and to block out UV light.

Interest in the technology to prevent breakage in the panoramic sunroof has recently been rising; for example, some video clips on the breakage of panoramic sunroofs are presented to the public on the Internet, and the Ministry of Land, Infrastructure and Transport has submitted an official proposal on the safety of the panoramic sunroof to the World Forum for Harmonization of Vehicle Regulations (WP29).

Being of a structure substantially vulnerable to impact because of glass as its structure material, the panoramic sunroof uses a tempered glass that secures strength high enough to endure a certain level of impact. Recently, the breakage of the above-mentioned region with a ceramic coating layer formed on has become an issue. More specifically, according to the sustained complaints in recent years, almost every panoramic sunroof is liable to break when the impact point is positioned in the region with the ceramic coating layer on. FIG. 2 shows images of breakage, which differs from the phenomenon called “self-failure” that usually occurs in the glass material. In addition, the impact tests performed on the panoramic sunroof according to the international standards by Korea Automobile Testing & Research Institute last year have revealed that when a 227 g steel ball is dropped from a defined height, the non-coated tempered glass has no damage but every region of the tempered glass with the ceramic coating layer on is likely to break without exception.

### BRIEF SUMMARY

For solving the problems with the prior art, it is an object of the present invention to provide a technique of preventing breakage in the region with a ceramic coating layer vulnerable to impact and likely to break in a panoramic sunroof glass panel by providing a physical/chemical/mechanical buffer layer between the ceramic coating layer and the tempered glass

In accordance with one embodiment of the present invention, for the sake of achieving the object of the present invention, there is provided a buffer layer for preventing breakage of a glass panel for panoramic sunroof installed on a vehicle, which buffer layer is formed in an interface between a tempered glass constituting the glass panel and a ceramic coating layer, in a region having the ceramic coating layer formed on the tempered glass. The buffer layer comprises a coating material as a constituent component, and the coating material is physicochemically stable and capable of reducing a stress difference between the tempered glass and the ceramic coating layer. In this regard, the thickness of the buffer layer may be in the range of 0.1 μm to 5 μm.

The coating material may comprise at least any one or a mixture or a compound of at least two selected from the group consisting of an oxide, a nitride and a carbide. Preferably, the coating material may comprise at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WI₃, B₂O₃, NbO, Rh₂O, Sc₂O₃, Ta₂O₅, and Yb₂O₃; at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TiC, Cr₃C₂, Al₄C₃, TaC, HfC, Be₂C, NbC, VC, ZrC, LaC, and FeC₃; a mixture of at least two thereof; or a compound of at least two thereof. More preferably, the coating material may be alumina (Al₂O₃).

In accordance with another embodiment of the present invention, for the sake of achieving the object of the present invention, there is provided a glass panel for panoramic sunroof installed on a vehicle. The glass panel comprises: a tempered glass; a buffer layer applied to a defined region on the tempered glass; and a ceramic coating layer applied to a region having the buffer layer formed thereon. The buffer layer comprises a coating material that is physicochemically stable and capable of reducing a stress difference between the tempered glass and the ceramic coating layer. In this regard, the thickness of the buffer layer may be in the range of 0.1 μm to 5 μm.

The coating material may comprise at least any one or a mixture or a compound of at least two selected from the group consisting of an oxide, a nitride and a carbide. Preferably, the coating material may comprise at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃; at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TiC, Cr₃C₂, Al₄C₃, TaO, HfC, Be₂C, NbC, VC, ZrC, LaC, and FeC₃; a mixture of at least two thereof; or a compound of at least two thereof. More preferably, the coating material may be alumina (Al₂O₃).

The buffer layer may be provided in the form of a multi-layer of at least two butter layers between the tempered glass and the ceramic coating layer. The multi-layer may include at least two buffer layers successively laminated between the tempered glass and the ceramic coating layer, or have at least two buffer layers and the ceramic coating layer alternately formed on the tempered glass.

In accordance with further another embodiment of the present invention, for the sake of achieving the object of the present invention, there is provided a method for manufacturing a glass panel for panoramic sunroof installed on a vehicle, which method comprises: (S10) performing a pre-treatment for cutting an original tempered glass; (S20) forming a buffer layer in a defined region on the pretreated tempered glass, the buffer layer comprising a coating material physicochemically stable and capable of reducing a stress difference between the tempered glass and a ceramic coating layer; (S30) forming the ceramic coating layer in the region with the buffer layer formed thereon; and (S40) performing an after-treatment by heating, molding and cooling the tempered glass with the buffer layer and the ceramic coating layer formed on.

The coating material may comprise at least any one or a mixture or a compound of at least two selected from the group consisting of an oxide, a nitride and a carbide. Preferably, Preferably, the coating material may comprise at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃; least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TiC, Cr₃C₂, Al₄C₃, TaC, HfC, Be₂C, NbC, VC, ZrC, LaC, and FeC₃; a mixture of at least two thereof; or a compound of at least two thereof. More preferably, the coating material may be alumina (Al₂O₃).

The thickness of the buffer layer formed in the step S20 of forming the buffer layer may be in the range of 0.1 μm to 5 μm. The step (S20) of forming the buffer layer may comprise successively forming at least two buffer layers into a multi-layer. Alternatively, the step (S20) of forming the buffer layer and the step (S30) of forming the ceramic coating layer may be alternately performed to form at least two buffer layers and the ceramic coating layer alternately on the tempered glass.

The buffer layer for preventing breakage of a glass panel for panoramic sunroof, the glass panel including the buffer layer, and the manufacturing method for the glass panel according to the present invention provide a buffer layer formed in an interface between the tempered glass and the ceramic coating layer in a region with the ceramic coating layer relatively vulnerable to impact, thereby physicochemically reducing the increase of the instability caused by the counter diffusion in the interface and relieving the concentration of the mechanical stress in the interface, only to effectively prevent breakage in the region with the ceramic coating layer formed on.

### BRIEF DESCRIPTION OF THE DRAWINGS

FIG. 1 shows a schematic structure of a panoramic sunroof glass panel.

FIG. 2 shows images of breakages in a panoramic sunroof.

FIG. 3 is a schematic diagram showing a process of forming a ceramic coating layer on a tempered glass in a panoramic sunroof.

FIG. 4 shows SEM (Scanning Electron Microscopy) images of the pulverized sample of the ceramic coating layer and its surface.

FIG. 5 shows the results of an EDS (Energy Dispersive Spectroscopy) compositional analysis through the SEM images of the sample surface in FIG. 4.

FIGS. 6a and 6b show AFM (Atomic Force Microscope) images for evaluating the roughness of the glass panel sample: FIG. 6a is a surface image of a sample prior to forming a ceramic coating layer; and FIG. 6b is a surface image of the sample with the ceramic coating layer formed on.

FIG. 7a is an SEM image showing the cross-section in the region having the ceramic coating layer formed on; and

FIG. 7b shows the results of an EDS compositional analysis on the cross-section.

FIG. 8 is an enlarged EDS image of the cross-section of FIG. 7a, showing the results of an analysis on the element compositions of the upper (blue region) and lower (red region) parts of the cross-section.

FIG. 9 is a process chart showing the process of applying a ceramic coating layer to an original tempered glass to form a glass panel.

FIG. 10 is a comparative example model corresponding to a conventional glass panel in a simulation experiment of the present invention.

FIG. 11 shows the simulation load conditions corresponding to the process conditions of FIG. 9 in the simulation experiment of the present invention.

FIGS. 12a-12d show the property values of the individual layer components used in the simulation experiment of the present invention; thermal conductivity in FIG. 12a, elastic modulus in FIG. 12b, thermal expansion coefficient in FIG. 12c, and plastic strain under yield stress (MPa) or above in FIG. 12d.

FIG. 13 presents the results of the simulation experiment of the present invention in which the comparative example model of FIG. 10 corresponding to the conventional glass panel is measured in regards to the bending stress σ₁₁ and shearing stress σ₁₂ under the load conditions of FIG. 11.

FIG. 14 is an example model corresponding to a glass panel according to a preferred embodiment of the present invention in a simulation experiment of the present invention.

FIG. 15 presents the results of the simulation experiment of the present invention in which the example model of FIG. 14 corresponding to the glass panel according to a preferred embodiment of the present invention is measured in regards to the bending stress σ₁₁ under the load conditions of FIG. 11.

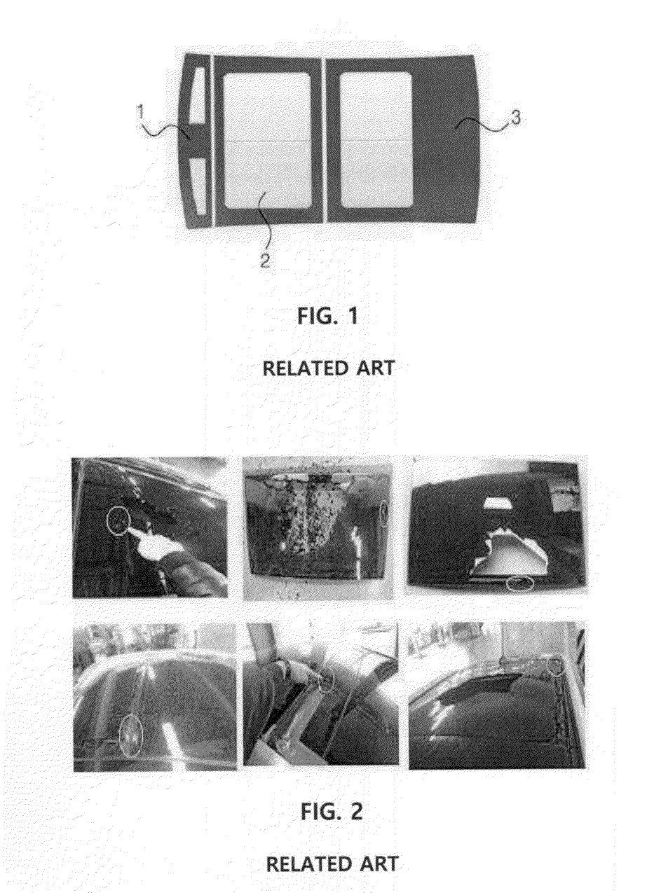

### DETAILED DESCRIPTION

Reference will be now made in detail to exemplary embodiments of the disclosure with reference to the attached drawings. It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the disclosure.

The present invention provides a buffer layer for Preventing breakage of a panoramic sunroof glass panel installed on a vehicle, a glass panel including the buffer layer, and a method for manufacturing the glass panel.

The present invention has been contrived in the course of studying the recent issue regarding the breakage of panoramic sunroofs, more specifically, the breakage in the region having a ceramic coating layer in panoramic sunroofs and proposing a solution to the problem.

Hereinafter, the process will be described in further detail.

First of all, a description will be given as to the material for the glass panel constituting a panoramic sunroof and its manufacturing process as follows.

The glass panel for panoramic sunroof is generally made of a tempered glass and complies with the Korea Motor Vehicle Safety Standards in regards to the structure and safety performances. Articles 34 and 105 of the standards describe the standards for the automotive glass and, particularly, Article 105 states that the glass panel should meet certain requirements on the mechanical strengths.

The tempered glass is a type of glass processed by thermal treatment (heated at 500 to 700° C. and then rapidly cooled with forced air drafts) to intentionally form a layer with very large compressive stresses on the surface and thus improve in the strength against external force and thermal variation. Advantageously, the tempered glass has significantly added strengths, does not break into sharp pieces, and is easy to make forms and light in weight.

For use in motor vehicles, the tempered glass is required to pass a defined impact test and ensured to have a certain minimum strength. The rules of operation on the motor vehicle glass panel test require that the glass panel be of no damage when a 227 g steel ball is dropped from the height of 2 m. These rules do not specify the height from which the steel ball should fall down. But, it is construed that the tempered glass should maintain a constant strength when a steel ball falls on from any height, in consideration of the rules of operation in the Korea Motor Vehicle Safety Standards defining the strength of the tempered glass in terms of “evenly tempered glass”.

On the other hand, a description will be given as to the “region with the ceramic coating layer” that is brought into question in the impact test. As described above, the ceramic coating layer is used to prevent damage on the surface of the glass possibly caused when the glass panel is operated to open/close, conceal the interior materials to enhance the external appearance, compensate for the problems caused by a bracket type connection or the like, and block out the UV light.

The ceramic coating composition is largely composed of three ingredients: glass frit that takes up to about 50 to 70% of the ceramic coating layer and contains Bi, Zn, etc.; a pigment that takes up to about 15 to 35% of the ceramic coating layer and determines the color; and a solvent or a resin used as a medium that takes up to about 15 to 35% of the ceramic coating layer and determines the viscosity. The total thickness of the ceramic coating layer is in the range of about 20 to 25 μm.

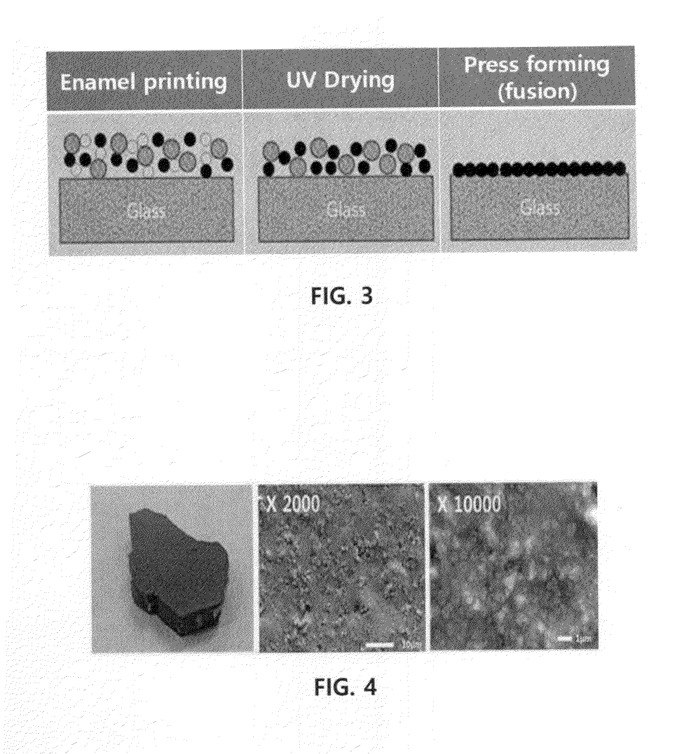

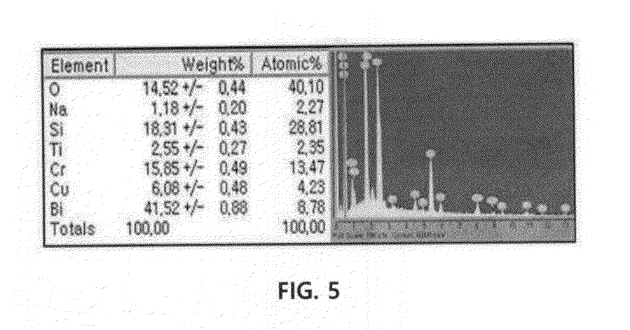

FIG. 3 is a schematic diagram showing a process of forming a ceramic coating layer. The glass frit has a similar composition to the glass of the substrate and functions to control the melting temperature of the ceramic coating material. In addition to the glass frit, the metal pigment is used to add some functions such as concealing the interior materials, enhancing the external appearance and blocking out the UV light, and the medium is controlled in composition to adjust the viscosity of the ceramic coating composition.

The ceramic coating composition is printed on the surface of the glass by screen printing, spray coating, or the like. Subsequently, UV drying or IR drying is performed to volatilize the medium component, and a press forming process using heat treatment is performed to fuse the glass frit and the pigment evenly onto the surface of the glass, thereby realizing the functions of the ceramic coating layer on the surface of the glass.

FIG. 4 shows SEM (Scanning Electron Microscopy) images of the surface of the sample made in the form of the pulverized piece with the ceramic coating layer formed on. Referring to FIG. 4, the surface of the ceramic coating region has a rough profile, which presumably results from the heat treatment. In addition, when enlarged more than 10,000 times in size, the glass frit has a surface profile with densification accelerated by the heat treatment.

According to the results of an EDS (Energy Dispersive Spectroscopy) compositional analysis on the surface of the sample, glass frit components, such as Si, O, Na, Bi, etc., and pigment components, such as Cr, Cu, Ti, etc., are detected. There is no carbon (C) atom detected, because the carbon (C) atoms added as a binder is all presumably volatilized during the heat treatment process.

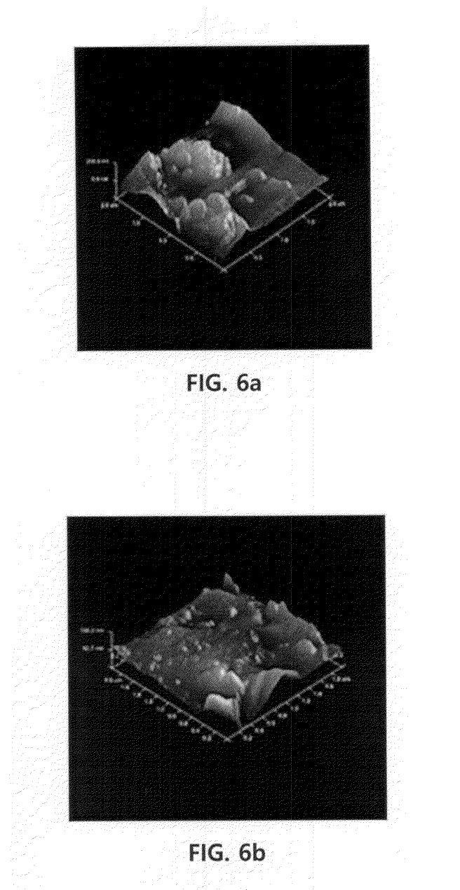

The roughness of the sample surface is evaluated using an AFM (Atomic Force Microscope. FIG. 6a is a surface image of the sample prior to forming a ceramic coating layer; and FIG. 6b is a surface image of the sample with a ceramic coating layer formed on. It is assumed that the fusion process of the ceramic coating layer and the heat treatment process result in enhanced evenness of the surface and a significant reduction of the particle size on the surface.

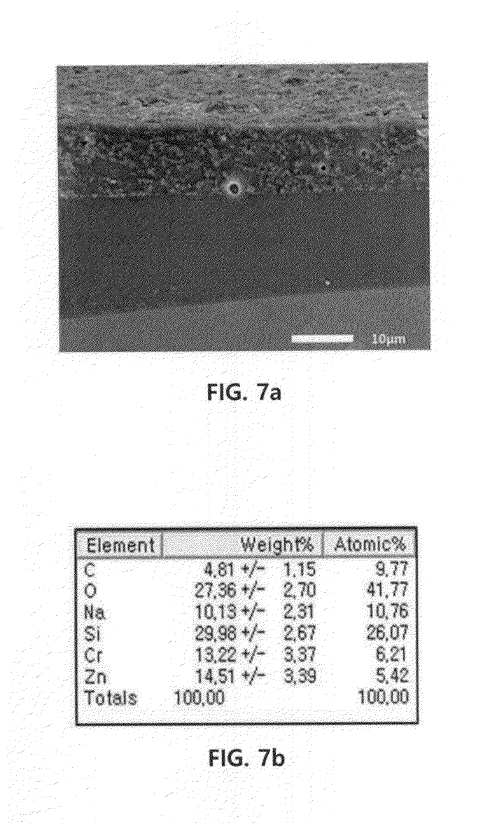

FIG. 7a is an SEM image showing the cross-section in the region having the ceramic coating layer formed on. The ceramic coating layer is about 12 μm in thickness. FIG. 7b shows the results of an EDS compositional analysis on the cross-section. As can be seen from the figure, carbon (C) atom is detected in the cross-section while no detection of carbon (C) appears on the surface, and the glass frit components, including Zn, Cr, etc., and the pigment components are also detected in the cross-section.

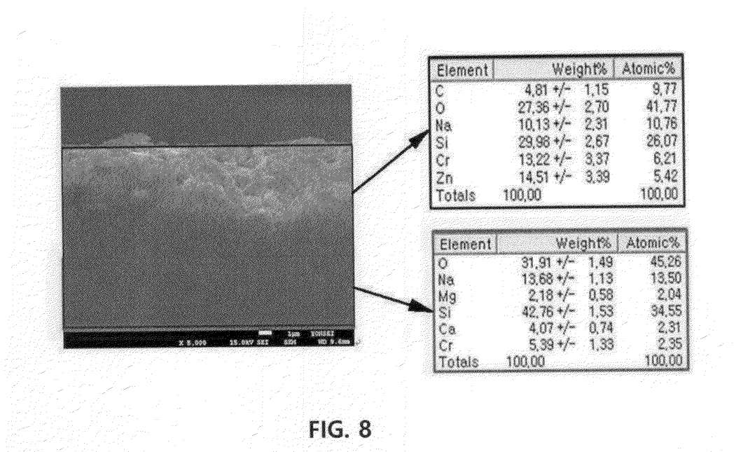

FIG. 8 is an enlarged EDS image of the said cross-section of the sample, showing the results of an analysis on the element compositions of the upper (blue region) and lower (red region) parts of the cross-section. In the lower part (in red), components such as Na, Ca, Mg, etc., are detected under the influence of the glass substrate, but the proportion of the metal components (e.g., Cr, Zn, etc.) is relatively small with respect to the total composition. In other words, Zn exists only in the topside of the coating layer, while Cr is distributed relatively much in the topside of the coating layer. This means that the metal elements are distributed relatively much in the surface.

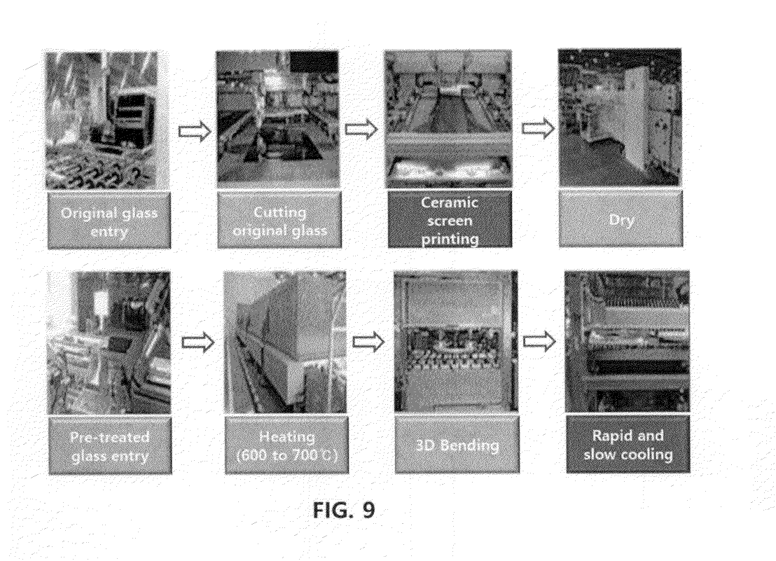

A schematic process chart of the manufacturing process for glass panel including a process of forming a ceramic coating layer is shown in FIG. 9. The manufacturing process for glass panel is divided into a pre-treatment process that involves cutting original flat glass, applying a ceramic coating composition by screen printing, and drying, and an after-treatment process that involves heating the pre-treated glass at 600 to 700° C., forming into a three-dimensional form, and rapidly cooling.

During the screen-printing step in the pre-treatment process, the ceramic coating composition is adsorbed using a roller or the like and then dried out. In this regard, the possibility of damage on the glass surface by the glass frit can be assumed depending on the load imposed on the roller. Further, additional regions may be found to be susceptible to breakage due to the difference between the residual stress possibly occurring during the heating, forming and rapid cooling steps and the stress on the interface between the coating layer and the glass. This is considered as the most important factor that should be taken into consideration when there is little or, if any, insignificant direct cracks or damages in the interface between the coating layer and the glass.

More specifically, there are three factors causing breakage in the panoramic sunroof as reasoned out in the course of contriving the present invention. The first factor is the second phase formed in the interface between the tempered glass and the ceramic coating layer during the printing, heating, forming and cooling processes for ceramic coating layer. The second phase causes the volume difference between the basic structure and the generated structure to incur deformation, which leads to stress functioning as a start point of breakage when an external impact is applied to the panoramic sunroof. The second factor is the diffusion rate difference in the interface between the tempered glass and the ceramic coating layer during the printing, heating, forming and cooling processes for ceramic coating layer. The difference in the diffusion rate incurs formation of irregular interfaces, among which sharp interfaces possibly act as crack tips and offer the start point of breakage when an external impact is applied to the panoramic sunroof. The last factor is a large stress difference in the interface between the tempered glass and the ceramic coating layer that results from the plastic strain caused by the printing, heating, forming and cooling processes for ceramic coating layer. Such an extremely large stress difference in the interface between the tempered glass and the ceramic coating layer leads to deterioration in the functions of the tempered glass that is forcedly subjected to plastic strain under stress, and a laminated structure vulnerable to breakage can be formed due to the stress difference.

Accordingly, the present invention is to effectively prevent breakage in the panoramic sunroof glass panel by forming a buffer layer in the interface between the tempered glass and the ceramic coating layer as a means of eliminating the three factors. The buffer layer includes, as a constituent component, a coating material physicochemically stable and capable of reducing the stress difference caused by the plastic strain between the tempered glass and the ceramic coating layer, thereby suppressing formation of the second phase in the interface through the chemical insulation (as a chemical buffer layer), reducing the stress difference caused by the laminated structure and the plastic strain (as a physical buffer layer).

The coating material may be any one of different materials that has physical/chemical stability, the ability of reducing the stress difference in the interface and, under necessity, appropriate characteristics (e.g., thermal conductivity, insulating properties, frequency properties, high-temperature stability, etc.). More specifically, the coating material may be any one or a mixture or a compound (i.e., oxynitride, oxycarbide or nitrogen carbide) of at least two selected from the group consisting of metal/metalloid/nonmetal oxide, nitride and carbide. Preferably, the coating material may comprise at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃, at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TIC, Cr₃C₂, Al₄C₃, TaC, HfC, Be₂C, NbC, VC, ZrC, LaC, and FeC₃; a mixture of at least two thereof; or a compound of at least two thereof. More preferably, the coating material may be alumina (Al₂O₃), which is excellent in chemical resistance, easy to apply onto the surface of the tempered glass and inexpensive.

Carbides, such as SiC or B₄C, used as a coating material, can offer excellent chemical properties, high hardness, high chemical stability and very low reactivity to other materials. In addition, the carbides are suitable to the manufacturing process for tempered glass due to their stability at high temperature and excellent in thermal resistance and thermal impact resistance, so they can be used as a coating material constituting the buffer layer of the present invention.

In this regard, the thickness of the buffer layer is preferably in the range of 0.1 to 5 μm. When less than 0.1 μm in thickness, the buffer layer is too thin to sufficiently achieve the functions as a chemical/physical buffer. When thicker than 5 μm, the buffer layer acts as another coating layer to affect the entire characteristics of the glass panel, which is poor economy.

On the other hand, the buffer layer may be provided in the form of a single layer including the alumina component, or when needed, in the form of a multi-layer of at least two buffer layers disposed between the tempered glass and the ceramic coating layer. In this regard, the multi-layer may be formed by successively laminating at least two buffer layers which are applied under different conditions in terms of composition, thickness, coating conditions, etc. to enhance the chemical insulating effect, and using the FGM (Functionally Graded Materials) method to reduce the difference in mechanical stress by phase. Alternatively, the multi-layer may be formed by alternately applying the ceramic coating layer and at least two of the buffer layer under the same or different conditions in terms of composition, thickness, coating conditions, etc. to enhance the mechanical strength more effectively.

Hereinafter, the solution of the present invention will be verified indirectly by means of simulation experiments, which is the most preferred embodiment of the present invention and does not represent all the technical concepts of the present invention. It is therefore construed as including all the variations and equivalents at the time of the application of the present invention.

### Example 1

### Simulation Experiment

### 1. Simulation Experiment on Comparative Example Model

### (1) Comparative Example Model Structure

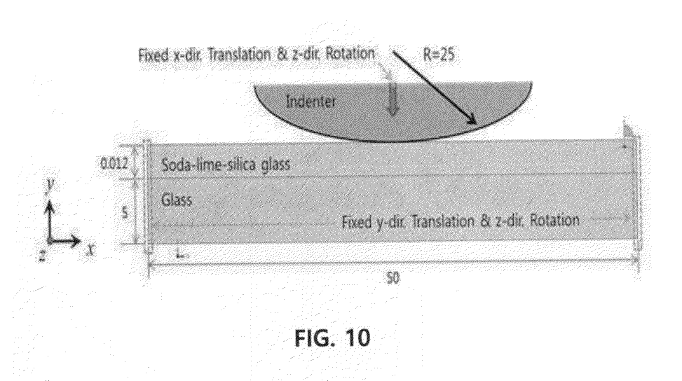

FIG. 10 is a comparative example model corresponding to a conventional glass panel. A simple model is used in the verification, as it is difficult to reconstruct the behaviors of an actual-size model. A glass and ceramic coating layer (soda-lime-silica glass) is formed 50 mm wide and 5.012 mm thick. As for the thickness, the ceramic coating layer is 12 μm and the glass layer is 5 mm. An indenter for use in the forming process is made to have a circular arc with a radius curvature of 25 mm. The boundary conditions are set to construct the both supports of a beam structure in the form of a simple support. The indenter is constructed to receive a vertical load. The indenter and the beam meet the contact conditions.

(2) Load Conditions

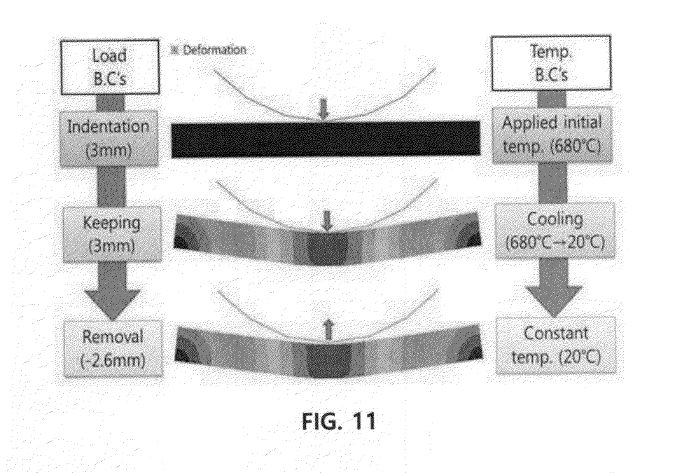

The simulation load conditions shown in FIG. 11 are given in correspondence to the above-described processing procedure for glass panel. While the thermal load conditions and the mechanical load conditions are separated out, in the initial stage, the temperature is raised to 680° C. and the indenter is moved down as far as mm to have the indenter in contact with the beam. Subsequently, the temperature is lowered to 20° C. under the rapid cooling conditions and the indenter is still kept in contact with the beam. With the temperature maintained at 20° C., the indenter is lifted up as far as about 2.6 mm. Such load conditions approximately reflect the processing conditions for glass panel in regards to the heating, forming and rapid cooling process.

(3) Material Properties

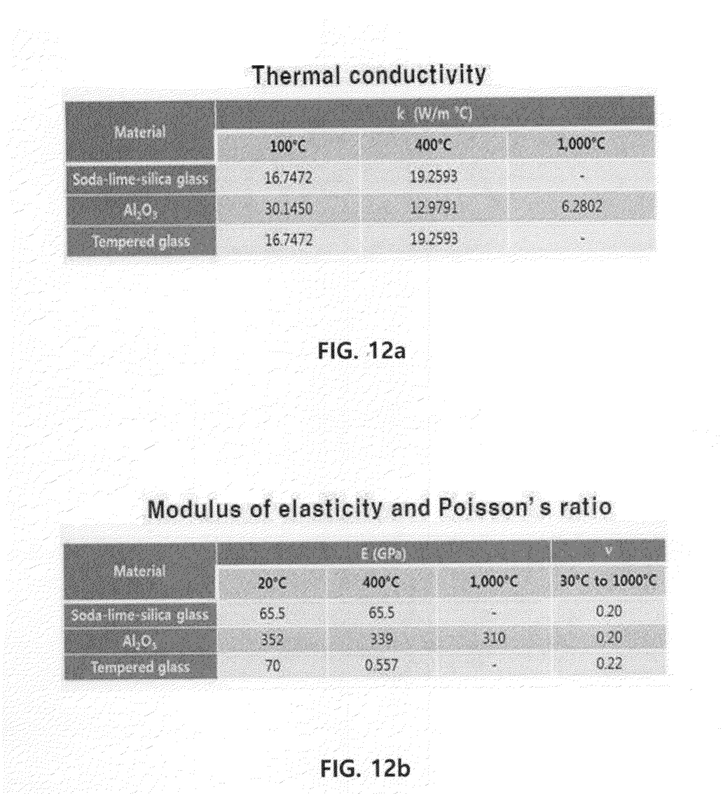

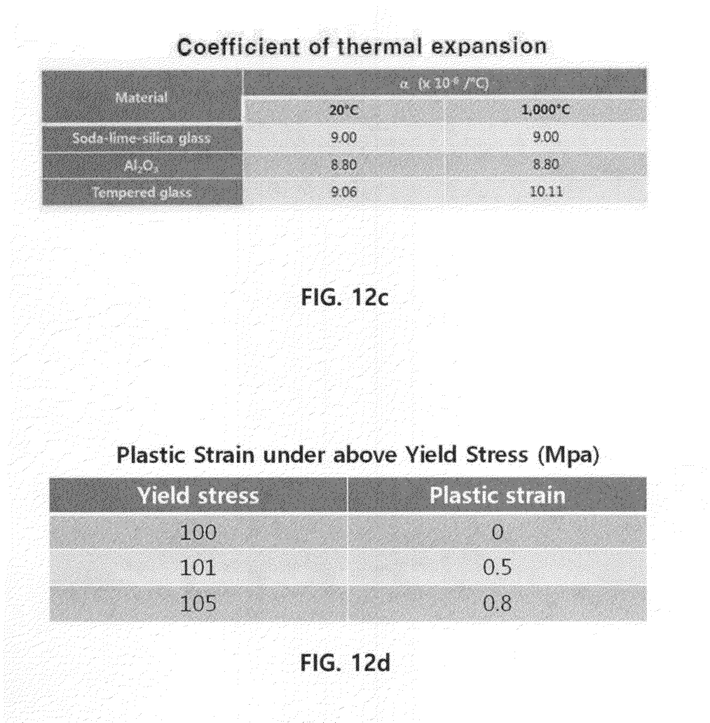

The properties of the individual materials used in the simulation experiment are presented in FIG. 12: thermal conductivity in FIG. 12a, elastic modulus in FIG. 12b, thermal expansion coefficient in FIG. 12c, and the property in regards to the plastic strain at above yield stress (MPa) in FIG. 12d. The values are the property values of the glass layer and the ceramic coating layer according to the temperature. The glass has a press forming behavior at around 680° C. and displays a change of plastic strain as shown in FIG. 12d.

(4) Simulation Results

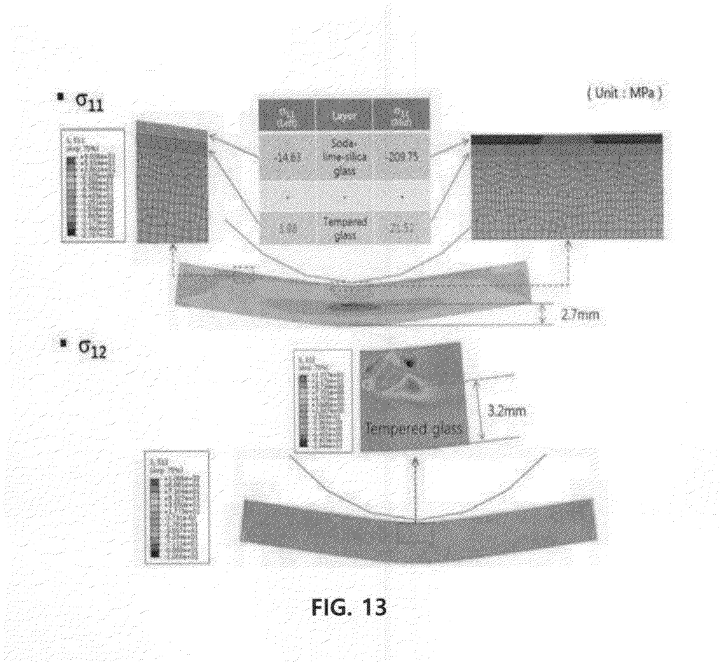

A simulation experiment is performed as described above. As a deformation occurs under the forming and bending loads, the measurements are performed in regards to the bending stress σ₁₁ and shearing stress σ₁₂ at the position of the maximum deformation and the position with the actual problem. The simulation results are presented in FIG. 13.

The first measurement position is the mid-position of the beam having the maximum bending moment, and the second measurement position is the position corresponding to one third of the left symmetric length from the left boundary of the simple support. After the cooling process, the beam is still bent and the residual stress occurs to cause, in the mid-position of the beam, compressive stress of about 209.75 MPa on the ceramic coating layer and tensile stress of about 21.52 MPa on the interface of the glass layer; and in the left-sided position, compressive stress of about 14.63 MPa on the ceramic coating layer and tensile stress of about 3.98 MPa on the interface of the glass layer.

As can be seen from the results, the glass layer is under the tensile force, and the stress difference in the interface between the glass layer and the coating layer is about 230 MPa in the mid-position and about 19 MPa in the left-sided position.

In consequence, the after-treatment process renders the glass to be an original glass under tensile force in contrast to the characteristics of the tempered glass and thus provides the glass with the environment that makes the glass more vulnerable to the mechanical load than the original glass. Further, the stress difference is considerably significant due to the laminated structure of the glass layer under tensile force and the coating layer under compressive force. In consideration of this fact, it is assumed that the breakage results from the stress difference in the interface between the ceramic coating layer and the glass layer and the tensile stress making the glass layer lose the characteristics as the tempered glass. Further, as described above, this problem may become worse when a second phase is chemically formed in the interface.

### 2. Simulation Experiment on Example Model

### (1) Example Model Structure

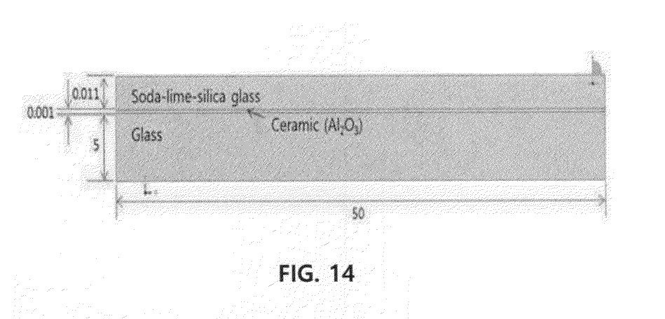

A simulation experiment is performed on an example model corresponding to the glass panel according to the preferred embodiment of the present invention as a structure that is constructed to solve the problems with the comparative example model and increase the mechanical strength by reducing the stress difference occurring in the interface. The example model of the present invention is illustrated in FIG. 14.

A buffer layer containing alumina that physicochemically enables ceramic fusion of the glass even at low temperature can enhance the fusion property, reduce the thermal load caused by the heat treatment process and decrease the stress difference in the aspect of the mechanical strength. Further, the buffer layer is so chemically stable as to suppress formation of a second phase in the interface between the coating layer and the glass layer.

The model is constructed under the same conditions, excepting that the thickness of the ceramic coating layer is reduced to 11 μm to make the buffer layer as thick as 1 μm. The boundary conditions and the load conditions are the same as specified in the case of the comparative example model.

(2) Simulation Results

A simulation experiment is performed as described above. As a deformation occurs under the forming and bending loads, the measurements are performed in regards to the bending stress σ₁₁ and shearing stress σ₁₂ at the position of the maximum deformation and the position with the actual problem.

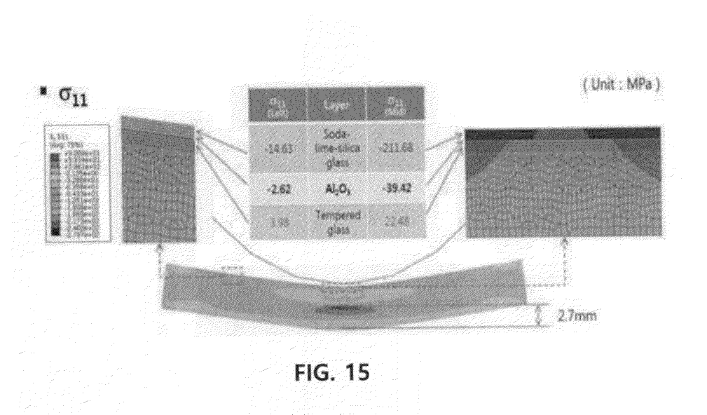

The results of the simulation on the improved example model are presented in FIG. 15. The simulation procedures are performed in the same manner as described in the case of the comparative example model to measure the stress at each position. But, the example model is measured in regards to the bending stress alone, in consideration of the fact that the simulation on the comparative example model shows the bending stress noticeably greater than the shear stress.

As can be seen from the results, the measurements in the mid-position are compressive stress of 211.68 MPa on the ceramic coating layer, tensile stress of 22.48 MPa on the interface of the glass layer and compressive stress of 39.42 MPa on the buffer layer; and the measurements in the left-sided position are compressive stress of 14.63 MPa on the ceramic coating layer, tensile stress of 3.98 MPa on the interface of the glass layer, and compressive stress of 2.62 MPa on the buffer layer.

Inserting the buffer layer between the glass layer and the coating layer makes no difference in the fact that the tensile stress is imposed on the whole glass but relatively reduces the stress difference between the glass layer and the coating layer to the significant extent. In other words, the comparative example model has the stress difference between the glass layer and the coating layer as much as about 230 MPa in the mid-position and about 19 MPa in the left-sided position, while the example model has the stress difference between the buffer layer and the glass layer as much as about 60 MPa in the mid-position and about 6 MPa in the left-sided position. As a result, the stress difference is reduced to about 25% in the mid-position and about 30% in the left-sided position.

In addition, a simulation experiment is performed to apply the same load conditions to the example model. As already mentioned above, the insertion of the buffer layer actually enhances the adhesiveness and eliminates the need for such a high forming temperature as high as the load conditions. It is therefore predicted that the actual measurements of the residual stress and the bending stress in the interface would be more improved than the simulation results.

Further, the embodiments discussed have been presented by way of example only and not limitation. Thus, the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the I invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A buffer layer for preventing breakage of a glass panel for panoramic sunroof, which is for automobile,
the buffer layer being formed in an interface between a tempered glass constituting the glass panel and a ceramic coating layer in a region having the ceramic coating layer formed on the tempered glass,
the buffer layer comprising a coating material,
the coating material comprising any one or a mixture or a compound of at least two selected from the group consisting of an oxide, a nitride and a carbide physicochemically stable and capable of reducing a stress difference between the tempered glass and the ceramic coating layer.

2. The buffer layer as claimed in claim 1, wherein the coating material comprises at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃; at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TiC, Cr₃C₂, Al₄C₃, TaC, HfC, Be₂C, NbC, VC, ZrC, LaC, and FeC₃; a mixture of at least two thereof; or a compound of at least two thereof.

3. The buffer layer as claimed in claim 1, wherein the coating material is alumina (Al₂O₃).

4. A glass panel for panoramic sunroof, which is for automobile, the glass panel comprising:
a tempered glass;
a buffer layer applied to a defined region on the tempered glass; and
a ceramic coating layer applied to a region having the buffer layer formed thereon,
the buffer layer comprising a coating material,
the coating material comprising any one or a mixture or a compound of at least two selected from the group consisting of an oxide, a nitride and a carbide physicochemically stable and capable of reducing a stress difference between the tempered glass and the ceramic coating layer.

5. The glass panel for panoramic sunroof as claimed in claim 4, wherein the coating material comprises at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃; at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TiC, Cr₃C₂, Al₄C₃, TaC, HfC, Be₂C, NbC, VC, ZrC, LaC, and FeC₃; a mixture of at least two thereof; or a compound of at least two thereof.

6. The glass panel for panoramic sunroof as claimed in claim 4, wherein the coating material is alumina (Al₂O₃).

7. The glass panel for panoramic sunroof as claimed in claim 4, wherein the buffer layer is provided in the form of a multi-layer of at least two buffer layers between the tempered glass and the ceramic coating layer.

8. The glass panel for panoramic sunroof as claimed in claim 7, wherein the multi-layer includes at least two buffer layers successively laminated between the tempered glass and the ceramic coating layer, or has at least two buffer layers and the ceramic coating layer alternately formed on the tempered glass.

9. A method for manufacturing a glass panel for panoramic sunroof, which is for automobile, the method comprising:
(S10) performing a pre-treatment for cutting an original tempered glass;
(S20) forming a buffer layer in a defined region on the pretreated tempered glass, the buffer layer comprising a coating material, the coating material comprising any one or a mixture or a compound of at least two selected from the group consisting of an oxide, a nitride and a carbide physicochemically stable and capable of reducing a stress difference between the tempered glass and a ceramic coating layer;
(S30) forming the ceramic coating layer in the region with the buffer layer formed on; and
(S40) performing an after-treatment by heating, molding and cooling the tempered glass with the buffer layer and the ceramic coating layer formed on.

10. The method as claimed in claim 9, wherein the coating material comprises at least one oxide selected from the group consisting of ZrO₂, CeO₂, Y₂O₃, HfO₂, MgO, SiO₂, TiO₂, ZnO, Al₂O₃, V₂O₅, In₂O₃, MoO₃, WO₃, B₂O₃, NbO, Rh₂O, Sc₂O₃, Ta₂O₅, and Yb₂O₃; at least one nitride selected from the group consisting of AlN, GaN, Si₃N₄, InN, TaN, CrN, TiN, ZrN, YN, BN, VN, C₃N₄, Be₃N₂, TiAlN, and WN; at least one carbide selected from the group consisting of SiC, B₄C, WC, TIC, Cr₃C₂, Al₄C₃, TaC, HfC, Be₂C, NbC, VC, ZrC, LaC, and FeC₃; a mixture of at least two thereof; or a compound of at least two thereof.

11. The method as claimed in claim 9, wherein the coating material is alumina (Al₂O₃).

12. The method as claimed in claim 9, wherein the step (S20) of forming the buffer layer comprises successively applying at least two buffer layers to form a multi-layer.

13. The method as claimed in claim 9, wherein the step (S20) of forming the buffer layer and the step (S30) of forming the ceramic coating layer are alternately performed to form at least two buffer layers and the ceramic coating layer alternately on the tempered glass.
